(19) United States
(12) Patent Application Publication
(10) Pub. No.: US 2003/0115306 A1
(43) Pub. Date: Jun. 19, 2003

(54) Modification of map of storage area network resources

(76) Inventors: Richard Hagarty, Roseville, CA (US); Eric D. Hubbard, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/020,954

(22) Filed: Dec. 19, 2001

(51) Int. Cl. G06F 15/173

(52) U.S. Cl. 709/223; 709/238

(57) ABSTRACT

A storage area network (SAN) management system for a computer network includes at least one SAN with a plurality of devices. A computer communicates with the SAN. A SAN manager is associated with the computer. A discovery module automatically discovers the devices and links between the devices. A storage area mapping (SAM) module graphically represents the devices of the SAN and links between the devices. The SAM module allows an operator to add a link between the devices, to remove a link between the devices and/or to move a link between the devices.

### FIELD OF THE INVENTION

The present invention relates to storage area networks, and more particularly to the mapping of storage area networks.

### BACKGROUND OF THE INVENTION

A computer network of a business may have multiple storage networks that are located remote from one another and a business user. The storage networks may also be hosted on different types of systems. To perform the job correctly, the business user may require fast and reliable access to the data contained in all of the storage networks. Information Technology (IT) employees must be able to provide high-speed, reliable access to the business users.

Storage area networks (SANs) are high-speed, high-bandwidth storage networks that logically connect the data storage devices to servers. The business user, in turn, is typically connected to the data storage devices through the server. SANs extend the concepts offered by traditional server/storage connections and deliver more flexibility, availability, integrated management and performance. SANs are the first IT solutions to allow users access to any information in the enterprise at any time. Generally the SAN includes management software for defining network devices such as hosts, interconnection devices, storage devices, and network attach server (NAS) devices. The SAN management software also allows links to be defined between the devices.

As various alternatives are in use today and have specific areas of application, the ability to integrate multiple technologies within an enterprise is very important. When each of these performance solutions are tuned in a networked system, there is a “sweet spot”. This point is where the convergence of the technologies enables the highest levels of performance to the enterprise. Only a company that can offer expertise in client, storage and server environments and technologies can deliver a solution whose performance and value is greater than the sum of the individual parts. Understanding how each technology functions, where they best fit, and how they work together is vital when making storage network hardware and software decisions.

One important component in reaching this goal is to allow the SAN to be fully understood by those designing and maintaining the SAN. It is often difficult to quickly understand the SAN due to its complexity. Tools that allow the configuration of the SAN to be understood and changed quickly would also be beneficial.

### SUMMARY OF THE INVENTION

A storage area network (SAN) management system according to the present invention for a computer network includes at least one SAN with a plurality of devices. A computer communicates with the SAN. A SAN manager is associated with the computer. A storage area mapping (SAM) module is associated with the SAN manager. The SAM module graphically represents the devices of the SAN and links between the devices. The SAM module allows adding a link between the devices, removing a link between the devices, and/or moving a link between the devices.

In other features of the invention, a discovery device that is associated with the SAN manager automatically discovers the devices and the links of the SAN. The SAM module generates a window with a tree list panel and a map panel. The map panel includes a tool bar with a plurality of icons, a first display area and a second display area. The SAM module displays a map of the devices with defined links in the first display area and the devices with undefined links in the second display area.

In other features, the computer includes a pointing device and the SAM module provides link details of a first link when the pointing device is positioned over the first link for a first predetermined period. The SAM module also provides device details of a first device when the pointing device is positioned over the first device for a second predetermined period.

In still other features, a device type of the devices is displayed using shapes and a device status of the devices is displayed using color. Link types of the links are displayed using line segment types and link status of the links is displayed using color. The SAM module also allows a discovered device to be associated with an inferred hub.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates storage area networks (SANs), a computer running a SAN manager, a storage area mapping (SAM) module, and a discovery module according to the present invention;

FIG. 2 illustrates a graphical user interface (GUI) for the SAM module;

FIG. 3 illustrates shapes that are used by the SAM module to graphically represent the different devices in the available SANs;

FIG. 4 illustrates colors and/or patterns that are used by the SAM module to graphically represent the status of the devices in the available SANs;

FIG. 5 illustrates colors and/or line patterns that are used by the SAM module to graphically illustrate link types and link status;

FIG. 6 illustrates tooltips generated by the SAM module to provide additional detailed information about the links and the devices;

FIGS. 7 and 8 illustrate an add link dialog box and an add link confirmation box;

FIGS. 9 and 10 illustrate a remove link dialog box and a remove link confirmation box;

FIGS. 11 and 12 illustrate a move link dialog box and a move link confirmation box; and

FIG. 13 illustrates an associate interconnect device dialog box.

### DETAILED DESCRIPTION OF THE PREFERRED EMBODIMENTS

The following description of the preferred embodiment(s) is merely exemplary in nature and is in no way intended to limit the invention, its application, or uses.

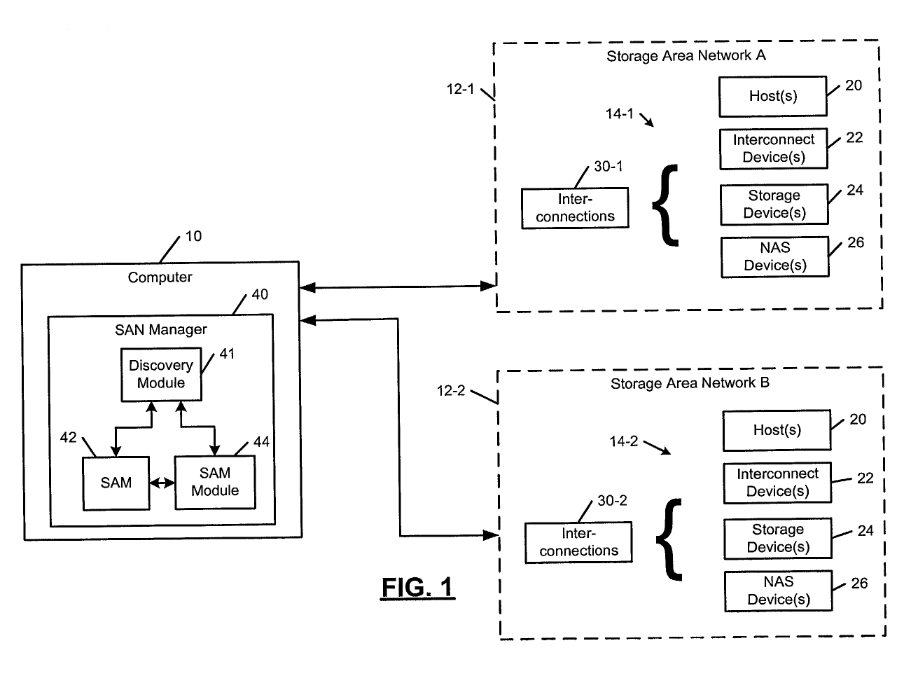

Referring now to FIG. 1, a computer 10 is connected to one or more storage area networks (SANs) 12-1, 12-2, . . . , and 12-n including storage network devices 14-1, 14-2, . . . , and 14-n, respectively. The SANs 12 include one or more of the following devices 14: hosts 20, interconnect devices 22, storage devices 24, and network attach server (NAS) devices 26. The devices 14 of the SANs 12 are interconnected in a variety of ways. To simplify FIG. 1, the specific interconnections of the devices 14-1 and 14-2 are generally labeled 30-1 and 30-2. Skilled artisans can appreciate that each device 14 can be connected to zero, one or more other devices 14.

The computer 10 includes a SAN manager 40 that is a computer program that is used to manage the SANs 12. For example, Hewlett Packard Storage Area Manager software is a suitable SAN manager. Other SAN managers may be employed. The computer 10 includes a pointing and selecting device such as a keyboard and/or a mouse. For purposes of clarity, the following description will include a mouse. However, other input/output devices are contemplated. In the preferred embodiment, a discovery module 41 automatically generates topology information based on data retrieved from the devices 14 that form the SAN 12. The discovery module 41 preferably employs standard protocols such as fibre channel, simple network management protocol (SNMP), small computer system interface (SCSI), or other suitable protocols. The data that is collected from the devices 14 is used to define links between the devices 14. From the collected device and link data, SAMs 42 are created by a SAM module 44. The SAMs 42 graphically illustrate the direct and indirect links between the devices 14 in the SAN 12.

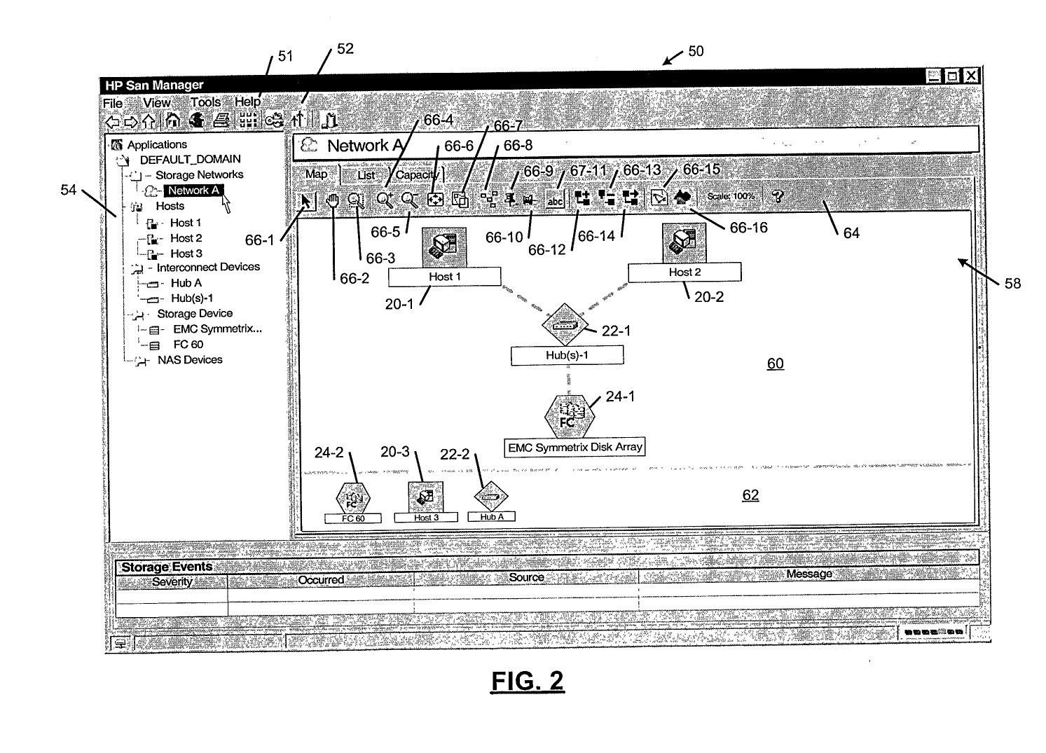

Referring now to FIG. 2, a graphical user interface (GUI) 50 of the SAN manager 40 and SAM module 44 is illustrated. As can be appreciated, the discovery device 41 and the SAM module 44 may be integrated with the SAN manager 40 or add-in components. The GUI 50 provides a conventional point and click interface and includes drop down menus 51 and a tool bar 52. The GUI 50 includes a tree list panel 54 and a map panel 58. The tree list panel 54 displays SANs available to the computer 40. The map panel 58 preferably includes an upper display area 60 that graphically depicts connected devices 14 and their associated links. A lower display area 62 graphically depicts devices 14 that have undetermined links.

The map panel 58 includes a map toolbar 64 with a plurality of tool icons 66. The tool icons 66 provide functionality to manipulate the map. Selecting a first icon 66-1 using the mouse and the cursor changes a current mouse mode to a pointer mode. The first icon 66-1 allows selections to be made within the map panel 58. Preferably only selected map nodes can be moved with the mouse. Selecting a second icon 66-2 changes the current map mode to a window pan mode. The second icon 66-2 allows the entire map to be moved within the map panel 58. This feature can be used to center the desired node(s) in the map panel 58.

Selecting a third icon 66-3 allows the operator to draw a rectangle around the objects to be displayed in a viewable region. The rectangle is zoomed such that any nodes outside the rectangle are no longer visible. Selecting fourth and fifth icons 66-4 and 66-5 allows the operator to zoom into or out of the viewable region. The icons 66-4 and 66-5 can be selected repeatedly until upper and lower zoom limits are reached. Selecting a sixth icon 66-6 automatically scales the map to allow all of the objects to be viewed within the viewable region.

Selecting a seventh icon 66-7 displays a sub-window with all of the map objects. From an overview window, the operator can drag a rectangle around the objects to be displayed in the map panel. As the rectangle is moved, the contents of the map panel change accordingly.

Selecting an eighth icon 66-8 re-draws the map window using the currently selected layout manager. As a result, all map objects will be in view. Selecting a ninth icon 66-9 pins the selected node or all nodes if none selected to the map. This will affix the selected node to the map surface and prevent re-layouts from affecting the position of the node. Selecting a tenth icon 66-10 un-pins a selected node or all nodes (if none selected) from the map. This will detach the node from the map surface allowing re-layouts to adjust the position of the node. Selecting an eleventh icon 66-11 shows or hides the node labels on the map. When selected, the icon 66-11 will appear depressed.

Selecting a twelfth icon 66-12 allows the operator to add links. Selecting a thirteenth icon 66-13 allows the operator to remove links. Selecting a fourteenth icon 66-14 allows the operator to move links. The icons 66-11, 66-12 and 66-13 are preferably enabled after one or two nodes have been selected.

Selecting a fifteenth icon 66-15 presents a layout manager dialog box. The layout manager dialog box determines how the nodes are laid out on the map panel. Selecting a sixteenth icon 66-16 presents a map legend sub-window. Selecting a seventeenth icon 66-17 presents a help screen at the map level.

As can be seen in FIG. 2, the displayed SAN 12 includes hosts 20-1, 20-2 and 20-3. The hosts 20-1 and 20-2 have identified links that are graphically depicted in the upper display area 60. Interconnect device 22-1 such as a hub is connected to the hosts 20-1 and 20-2. A storage device 24-1 such as a disk array is connected to the interconnect device 22-1. The host 20-3, a storage device 24-2 and an interconnect device 22-2 have undetermined links as graphically depicted in the lower display area 62. The tree list panel 54 displays a tree containing SANs 12 and the associated devices 14. As can be appreciated, the SAN tree folder may include more than one SAN.

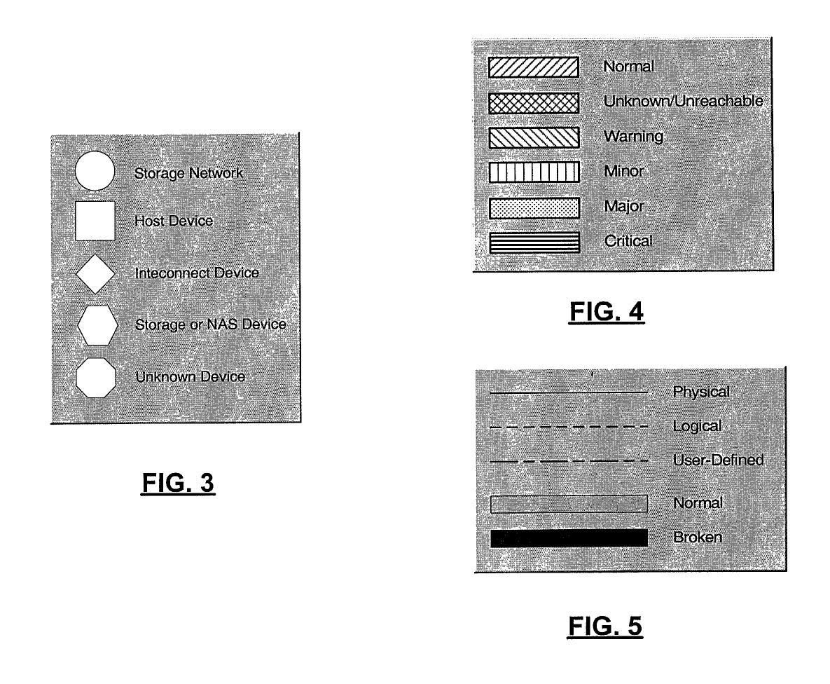

Referring now to FIG. 3, types of network devices 14 are graphically depicted on the map panel 58 using different geometric shapes. The different geometric shapes allow the devices 14 to be recognized readily by the operator. As can be appreciated, the specific shapes that are selected for the SANs 12 and the devices 14 can be changed. Referring now to FIG. 4, various different patterns or colors are used to identify the status of the SANs 12 and the devices 14. Referring now to FIG. 5, various different colors and/or line styles are used to identify linked sites and the status of the link.

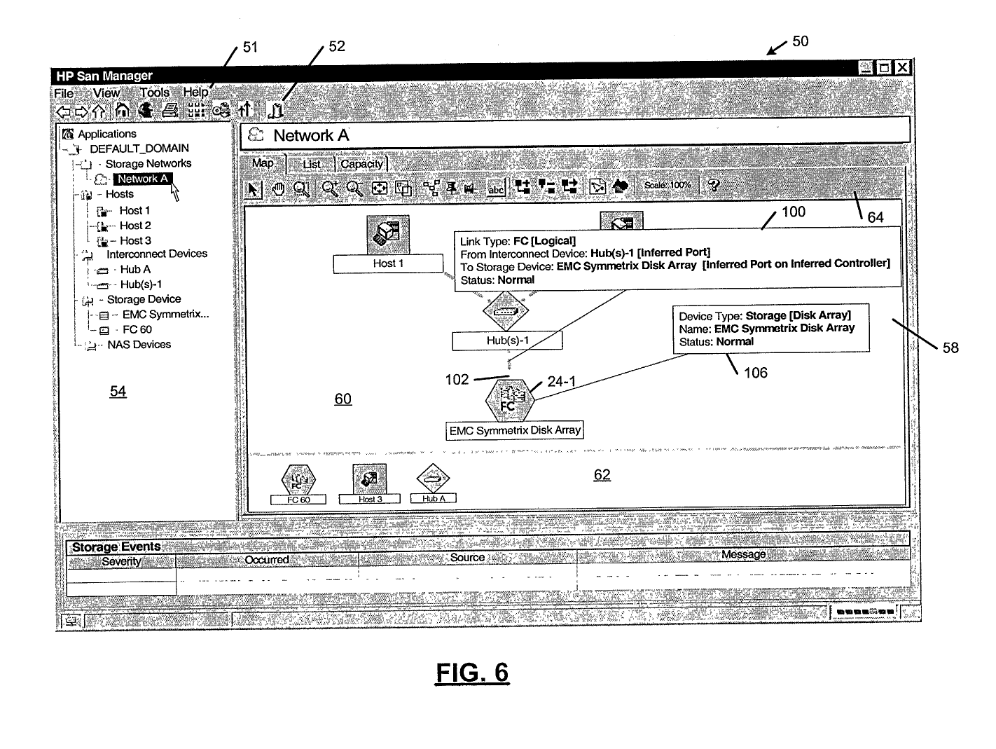

Referring now to FIG. 6, exemplary tooltips provided by the GUI 50 are shown. A first tooltip 100 is provided when the mouse is positioned over a link 102 for a predetermined period. A second tooltip 106 is provided when the mouse is positioned over the device 24-1 for a predetermined period. As can be appreciated by skilled artisans, positioning the mouse over a device or a link triggers a pop-up tooltip that shows a more detailed description of the link or device.

For a device, one or more of the following are displayed: the physical device type, the specific device type, name of the device, and status of the device. The physical device type preferably includes host, interconnect, storage, or unknown. The specific device type preferably includes host operating system version, bridge, hub, disk array, etc.

The additional detailed information provided by the tooltip for a link includes: physical link type, discovery link type, name of the port and the node that the link is coming from, name of the port and the node that the link is going to, and the status of the link. The physical link type includes fibrechannel, small computer system interface (SCSI), Ethernet or unknown. The discovery link type includes physical, inferred, and user defined.

After the discovery process of the discovery module 41 has created a SAM 42, the SAM module 44 provides tools to allow the operator to modify the SAM 42. Some of the tools change the layout and appearance of the map such as zoom, layout, pan, etc. Other tools physically change the topology of the map. The tools that change the topology of the map include adding a link between two devices, removing a link between two devices, moving an existing link (removing and adding a link in one step), and allowing a discovered device to be associated with an inferred hub.

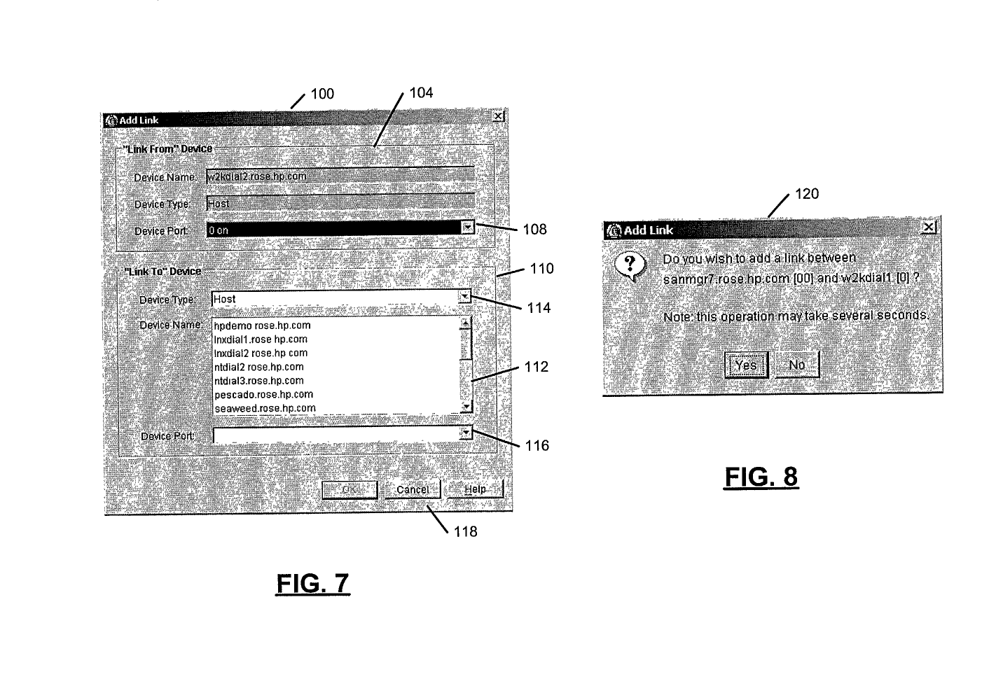

Referring now to FIG. 7, there are several ways to add a link between two devices 14. First, one or two devices 14 are selected. A right click on the mouse triggers a pop-up menu. The “Add Link Between Map Devices” menu item is selected. Second, one or two map devices are selected and the icon 66-12 is pressed on the map toolbar 64. Third, the device 14 is selected, dragged and dropped onto another device 14.

Once initiated, an add link dialog box 100 is displayed. A “Link From” frame 104 including device name and port is populated with information from the selected device 14. A device port pull down menu 108 is populated with available ports that can be selected. A “Link To” frame 110 including device type and name allows a device to a selected with a corresponding port. To reduce the number of devices 14 displayed in a device name selection box 112, the device type may be specified in a device type pull down menu 114. The device port pull down menu 116 is selected by the operator.

If two devices are selected when the add link function is initiated, the device type and device name of the “Link To” frame 110 are populated with the information from the second selected device. The device port pull down menu 116 is still selected by the operator. If the drag and drop method was used to initiate the add link function, the device type and device name are populated with the information from the “dropped on” device. The device port pull down menu 116 is still selected by the operator.

After a valid set of selections have been made, the operator can select “OK”, “Cancel” or “Help” command buttons that are generally designated 118. The “Help” command button provides content specific help. Selecting the “Cancel” command button aborts the current add link procedure. Selecting the “Yes” command button confirms the add link procedure previously selected and launches a confirmation dialog box 120 shown in FIG. 8. Selecting “Yes” in the dialog box 120 confirms the add link procedure and selecting “No” aborts the add link procedure.

If the operator selects a device that is located in a different SAN 12 than the currently selected “Link From” device, the two SANs 12 are linked. This procedure joins the two SANs 12. The SAN 12 with a lower index number is populated with the nodes of the SAN 12 with a higher index number. The SAN 12 with the higher index number will be removed from the current view. Once the add link function is complete, the SAN manager 40 stores the new link information. The discovery process of the discovery module 41 takes the new user-defined information into account as it attempts to discover additional devices, links and topologies.

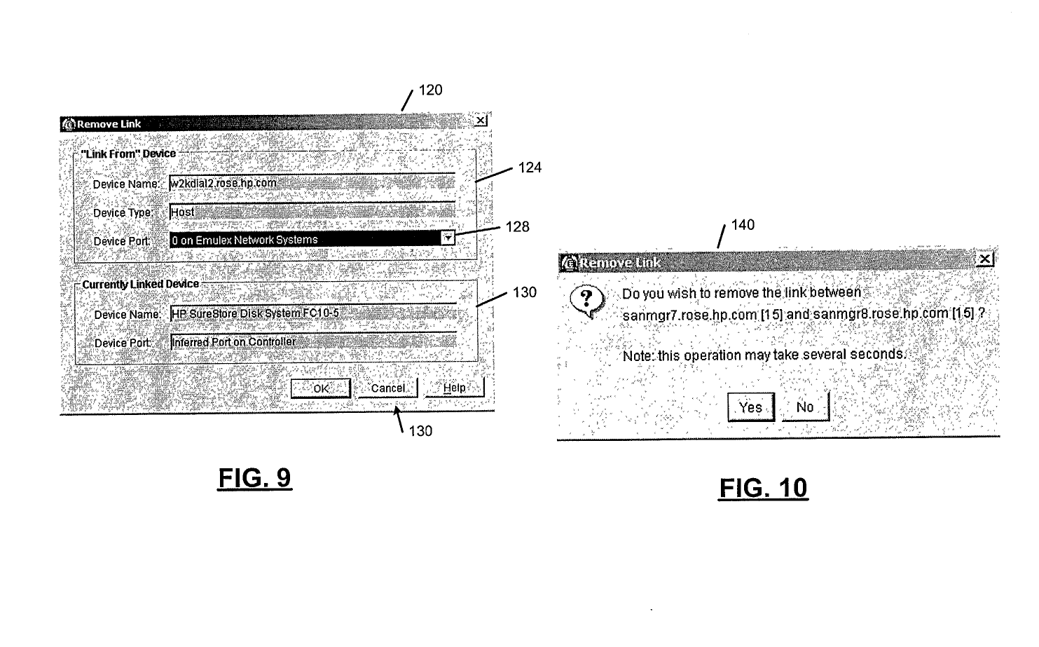

Referring now to FIG. 9, there are several ways to remove a link between two devices 14. First, one or two devices 14 are selected. A right mouse click on the mouse triggers a pop-up menu. The “Remove Link Between Map Devices” menu item is selected. Second, one or two devices 14 are selected and the icon 66-13 is pressed on the map toolbar 64. Third, a link is selected. A right mouse click triggers a pop-up menu. The “Remove Link” menu item is selected.

Once initiated, a remove link dialog box 120 is displayed. A “Link From” frame 124 including device name and type is populated with information from the selected device 14. A device port pull down menu 128 is populated with available ports that can be selected. A “Currently Linked Device” frame 130 is populated with a device name and a selected port based on the device port selected in pull down menu 128. If two devices are selected to initiate the remove link function or a link was selected, the device type and device name of the “Currently Linked Device” frame 130 are automatically populated.

After a valid set of selections have been made, the operator can select “OK”, “Cancel” or “Help” command buttons that are generally identified at 138. The “Help” command button provides content specific help. Selecting the “Cancel” command button aborts the current remove link procedure. Selecting the “Yes” command button confirms the remove link procedure previously selected and launches a confirmation dialog box 140 shown in FIG. 10. As can be appreciated, removing a link may separate a SAN into two SANs. Once the remove link function is complete, the SAN manager 42 stores the new link information. The discovery process of the discovery module 41 takes the new user-defined information into account as it attempts to discover additional devices, links and topologies.

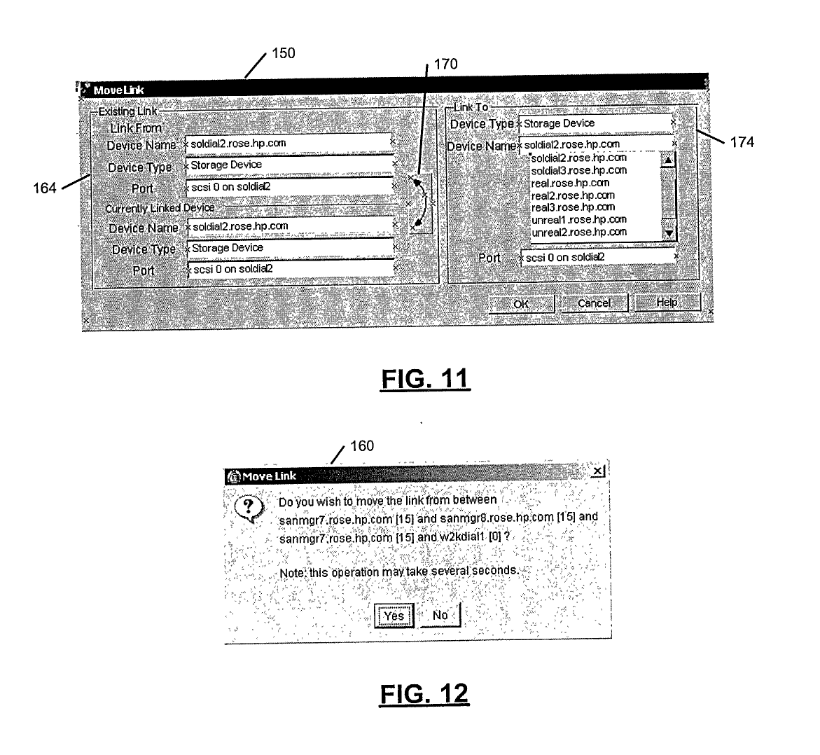

Referring now to FIGS. 11 and 12, a move link dialog box 150 and a move link confirmation box 160 are illustrated. Moving a link involves taking an existing link and moving it from one of the linked devices 14 to another device 14. For example, a link is discovered by the SAN manager 42 between devices A and B. The operator knows that the actual link is really between the device A and a device C. The operator can remove the link and then add the link in two steps or move the link in a single step.

There are several ways to move an existing link between two devices 14. First, one or two devices 14 are selected. The operator clicks the right button of the mouse and selects “Move Existing Link to a New Map Device” from the pop-up menu. Second, one or two devices 14 are selected. The icon 66-14 is pressed on the map toolbar 64. Third, a link is selected. The user presses the right button on the mouse and selects the “Move Link” from the pop-up menu.

Once initiated, the move link dialog box 150 is displayed. An existing link frame 164 details the link information for the current link. By changing a “Link From” port selection, the Currently Linked Device” section is populated automatically. An arrow command button 170 swaps the “Link From” device information with the “Currently Linked Device”. The arrow command button 170 allows the user to specify which device on the “Existing Link” side will remain.

A “Link To” frame 174 allows a device to be selected with a corresponding port. To reduce the number devices 14 that are displayed in the “Name” selection box, the device type may be specified. Selecting the “OK” command button triggers a move link confirmation box 160. Selecting the “Cancel” command button aborts the operation. Selecting the “Help” command button displays content specific help. As can be appreciated, the move link function may join two SANs and/or may separate a SAN into two SANs, Once complete, the SAN manager 42 stores the new link information. The discovery process of the discovery module 41 will take this new information into account as it attempts to discover additional devices, links and topologies.

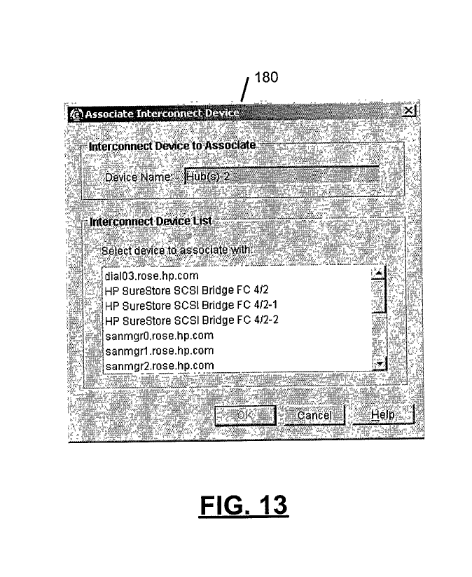

Referring now to FIG. 13, an associate interconnect device dialog box 180 is illustrated. An inferred hub is created by the discovery process of the SAN manager 40 when information is not available to determine the exact topology. When inferred hubs are discovered and placed on the map, the user can associate a discovered device with the inferred hub. This option is available by right mouse clicking on any inferred hub that is listed in the navigation tree and selecting “Associate Interconnect Device” on the pop-up menu. The associate interconnect device dialog box 180 is displayed.

Selecting a device to associate with and pressing the “OK” command button creates an association between the discovered device and the inferred hub. Selecting the “Cancel” aborts the operation. Selecting the “Help” command button displays content specific help. Once complete, the SAN manager 42 stores the new link information. The discovery process of the discovery module 41 will take this new information into account as it attempts to discover additional devices, links and topologies.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A storage area network (SAN) management system for a computer network including at least one SAN, comprising:
a SAN including a plurality of devices;
a computer that communicates with said SAN;
a SAN manager associated with said computer; and
a storage area mapping (SAM) module associated with said SAN manager that graphically represents said devices of said SAN and links between said devices, wherein said SAM module allows at least one of adding a link between said devices, removing a link between said devices and moving a link between said devices.

2. The SAN management system of claim 1 further comprising a discovery module associated with said SAN module that automatically discovers said devices and said links of said SAN.

3. The SAN management system of claim 2 wherein said SAM module generates a window with a tree list panel and a map panel.

4. The SAN management system of claim 3 wherein said map panel includes a tool bar with a plurality of icons, a first display area and a second display area.

5. The SAN management system of claim 4 wherein said SAM module displays a map of said devices with defined links in said first display area and said devices with undefined links in said second display area.

6. The SAN management system of claim 1 wherein said computer includes a pointing device and wherein said SAM module provides link details of a first link when a cursor is positioned over said first link for a first predetermined period, and wherein said SAM module provides device details of a first device when a cursor is positioned over said first device for a second predetermined period.

7. The SAN management system of claim 1 wherein said SAM module displays a device type of said devices using shapes and a device status of said devices using color.

8. The SAN management system of claim 1 wherein said SAM module displays link types of said links using line segment types and link status of said links using color.

9. The SAN management system of claim 1 wherein said SAM module allows an operator to associate a discovered device with an inferred hub.

10. A method for managing a storage area network (SAN), comprising:
connecting a SAN including a plurality of devices to a computer;
providing a SAN manager that is associated with a storage area mapping (SAM) module;
graphically representing said devices of said SAN and links between said devices of said SAN using said SAM module; and
allowing at least one of adding a link between said devices, removing a link between said devices and moving a link between said devices.

11. The method of claim 10 further comprising automatically discovering said devices and said links of said SAN using a discovery module that is associated with said SAN manager.

12. The method of claim 11 further comprising generating a window with a tree list panel of said SANs and said devices that are associated with said computer and a map panel.

13. The method of claim 12 further comprising providing a tool bar including a plurality of icons, a first display area and a second display area on said map panel.

14. The method of claim 13 further comprising:
displaying a map of said devices with defined links in said first display area; and
displaying said devices with undefined links in said second display area.

15. The method of claim 10 further comprising:
providing a pointing device;
generating link details of a first link when a cursor is positioned over said first link for a first predetermined period; and
generating device details of a first device when a cursor is positioned over said first device for a second predetermined period.

16. The method of claim 10 further comprising:
displaying a device type of said devices using shapes; and
displaying a device status of said devices using color.

17. The method of claim 10 further comprising:
displaying a link type of said links using line segments types; and
displaying a link status of said links using color.

18. The method of claim 10 further comprising allowing an operator to associate a discovered device with an inferred hub.

19. A storage area network (SAN) management system for a computer network including at least one SAN, comprising:
a SAN including a plurality of devices;
a computer that communicates with said SAN; and
a SAN manager associated with said computer;
a discovery module associated with said SAN manager that automatically discovers said devices and said links of said SAN; and
a storage area mapping (SAM) module associated with said SAN manager that graphically represents said devices of said SAN and said links between said devices,
wherein said SAM module allows at least one of adding a link between said devices, removing a link between said devices and moving a link between said devices.

20. The SAN management system of claim 19 wherein said SAM module allows an operator to associate a discovered device with an inferred hub.
